(19) United States
(12) Patent Application Publication
(10) Pub. No.: US 2025/0226585 A1
(43) Pub. Date: Jul. 10, 2025

(54) WAVEGUIDE ANTENNA STRUCTURE

(71) Applicant: HL KLEMOVE CORP., Incheon (KR)

(72) Inventors: Hyunseok LEE, Incheon (KR); Sungjoon HEO, Incheon (KR)

(21) Appl. No.: 19/016,729

(22) Filed: Jan. 10, 2025

(30) Foreign Application Priority Data
Jan. 10, 2024 (KR) 10-2024-0004166

(51) Int. Cl. H01Q 13/08; H01Q 5/55

(52) U.S. Cl. CPC H01Q 13/085; H01Q 5/55

(57) ABSTRACT

An antenna structure includes a base layer having a feed hole through which directly fed RF signals pass; a waveguide layer stacked on the base layer and having a waveguide in communication with the feed hole; and an antenna layer stacked on the waveguide layer and having one or more antenna holes for transmitting or receiving signals passing through the feed hole and the waveguide to or from the outside of the antenna structure.

### CROSS-REFERENCE TO RELATED APPLICATION

This application claims priority to and benefit from Korean Patent Application No. 10-2024-0004166, filed on Jan. 10, 2024, the disclosure of which is incorporated herein by reference in its entirety.

### BACKGROUND

### 1. Technical Field

The present disclosure generally relates to a waveguide antenna structure and apparatus, and more particularly, to a waveguide antenna structure in which one or more printed circuit boards (PCBs) are stacked.

### 2. Discussion of Related Art

Recently, antennas used in radar have been changed from a PCB type to a waveguide type.

Conventional waveguide-type antennas are manufactured in an aluminum structure or a plastic injection structure, and such a structure requires to transfer a signal from a microstrip to a waveguide.

However, this structure may have disadvantages in terms of high cost, antenna fabrication and fastening, and signal loss.

### SUMMARY

The present disclosure is to solve the above problems, and some embodiments of the present disclosure may be directed to a waveguide antenna structure of a direct power feeding type.

Certain embodiments of the present disclosure may be also directed to an antenna structure in which a waveguide is formed by stacking printed circuit boards (PCBs).

Some embodiments of the present disclosure may be also directed to an antenna structure that can be manufactured by stacking PCBs so that it can be used with a chip having a direct power feeding structure.

Certain embodiments of the present disclosure may provide a waveguide antenna technology that does not have a structure for transferring from a microstrip to a waveguide in a waveguide-type antenna.

The objects of the present disclosure are not limited to the above-described objects, and other objects that are not mentioned will be able to be clearly understood by those skilled in the art to which the present disclosure pertains from the following description.

According to an aspect of the present disclosure, a waveguide antenna structure is provided, including a base layer in which a feed hole through which directly fed RF signals pass is formed; a waveguide layer stacked on top of the base layer and having a waveguide in communication with the feed hole; and an antenna layer stacked on top of the waveguide layer and having an antenna for transmitting or receiving RF signals passing through the feed hole and the waveguide to/from the outside.

In this case, each of the antenna layer, the waveguide layer, and the base layer may include a board layer; and a first protective layer and a second protective layer stacked on the top surface and the bottom surface of the board layer, respectively.

In this case, the board layer is made of FR-4 material, and the first protective layer and the second protective layer may be made of a material that is conductive and capable of forming plating.

In this case, an adhesive layer may be interposed between the base layer and the waveguide layer and between the waveguide layer and the antenna layer, a plurality of via holes passing through the base layer, the waveguide layer, and the antenna layer, which are stacked together, may be formed in the base layer, the waveguide layer, and the antenna layer, and when viewed in a first direction in which the layers are stacked, the plurality of via holes may be arranged to surround the feed hole, the waveguide, and the antenna.

The antenna may be a slot antenna including a plurality of antenna holes.

In this case, the waveguide may be formed to extend in a second direction perpendicular to the first direction, the feed hole may be formed at one end of the waveguide in the second direction, and the one or more antenna holes may be spaced apart from the feed hole in the second direction and arranged at a predetermined interval along the extension direction of the waveguide.

In this case, when viewed in the first direction, the plurality of via holes may be arranged in a rectangular shape extending in the extension direction of the waveguide.

In this case, when viewed in the first direction the interval between neighboring via holes of the plurality of via holes may be less than or equal to ½λ of a frequency of an RF signal passing through the waveguide.

In this case, the plurality of antenna holes may be arranged in two rows along the extension direction of the waveguide, and neighboring antenna holes may be arranged to be staggered.

In this case, the via hole may have any one of a substantially circular, elliptical, quadrangular, or rectangular cross-section.

In this case, the waveguide antenna structure may further include two or more distribution waveguides connected to the other end of the waveguide, and the two or more distribution waveguides may extend in the second direction or include portions extending in a direction perpendicular to the second direction, and the interval between the second directions of the distribution waveguides may be less than or equal to 1λ.

In this case, the waveguide antenna structure may include two or more fastening members for coupling the base layer, the waveguide layer, and the antenna layer, and the two or more fastening members may be disposed on both sides of the base layer, the waveguide layer, and the antenna layer to couple the layers.

In this case, the waveguide antenna structure may further include a first plating layer formed on the inner surface of the waveguide and the inner surface of the antenna hole.

In this case, the two or more fastening members may include a bolt member, and the bolt member may be formed so that a head portion thereof is placed on the antenna layer, and the opposite end of the head portion may be formed to protrude through the base layer and be coupled to an RF board on which an MMIC chip that generates RF signals toward the feed hole is mounted.

In this case, the waveguide antenna structure may further include an adhesive layer interposed between the base layer and the waveguide layer or between the antenna layer and the waveguide layer, and a second plating layer may be formed between the base layer and the waveguide layer or between the antenna layer and the waveguide layer with the adhesive layer interposed therebetween.

The antenna may be a horn antenna or a patch antenna.

According to another aspect of the present disclosure, a waveguide antenna structure is provided, including a MMIC chip that generates RF signals; an RF board on which the MMIC chip is mounted on one surface and which has a feed hole for transmitting the RF signals generated by the MMIC chip; a waveguide layer stacked on the other surface of the RF board and having a waveguide in communication with the feed hole; and an antenna layer stacked on top of the waveguide layer and having one or more antenna holes for transmitting or receiving signals passing through the feed hole and the waveguide to/from the outside.

In this case, the waveguide antenna structure may include two or more fastening members for coupling the RF board, the waveguide layer, and the antenna layer, and the two or more fastening members may be disposed on both sides of the RF board, the waveguide layer, and the antenna layer to couple the layers.

In this case, the waveguide antenna structure may further include a first plating layer formed on the inner surface of the waveguide and the inner surface of the antenna hole.

In this case, the two or more fastening members may include a bolt member, and the bolt member may be formed so that a head portion thereof is placed on the antenna layer, and the opposite end of the head portion may be formed to protrude through the antenna layer and be coupled to the RF board.

In this case, the waveguide antenna structure may further include an adhesive layer interposed between the antenna layer and the waveguide layer, and a plating layer may be formed between the antenna layer and the waveguide layer with the adhesive layer interposed therebetween.

In this case, each of the antenna layer and the waveguide layer may include a board layer; and a first protective layer and a second protective layer stacked on the top surface and the bottom surface of the board layer respectively.

In this case, the board layer is made of FR-4 material, and the first protective layer and the second protective layer may be made of a material that is conductive and capable of forming plating.

In this case, an adhesive layer may be interposed between the waveguide layer and the antenna layer, a plurality of via holes passing through the waveguide layer and the antenna layer, which are stacked together, may be formed in the waveguide layer and the antenna layer, and when viewed in a first direction in which the layers are stacked, the plurality of via holes may be arranged to surround the feed hole, the waveguide, and the one or more antenna holes.

In this case, the waveguide may be formed to extend in a second direction perpendicular to the first direction, the feed hole may be formed at one end of the waveguide in the second direction, and the one or more antenna holes may be spaced apart from the feed hole in the second direction and arranged at a predetermined interval along the extension direction of the waveguide.

In this case, when viewed in the first direction, the plurality of via holes may be arranged in a rectangular shape extending in the extension direction of the waveguide.

In this case, when viewed in the first direction the interval between neighboring via holes of the plurality of via holes may be less than or equal to ½λ of a frequency of an RF signal passing through the waveguide.

In this case, the waveguide antenna structure may further include two or more distribution waveguides connected to the other end of the waveguide, and the two or more distribution waveguides may extend in the second direction or include portions extending in a direction perpendicular to the second direction, and the interval between the second directions of the distribution waveguides may be less than or equal to 1λ.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view of a direct power feeding type PCB stacked waveguide antenna structure according to an exemplary embodiment of the present disclosure;

FIG. 2 is a plan view of a direct power feeding type PCB stacked waveguide antenna structure according to an exemplary embodiment of the present disclosure;

FIG. 3 is a bottom view of a direct power feeding type PCB stacked waveguide antenna structure according to an exemplary embodiment of the present disclosure;

FIG. 4 is a cross-sectional view taken along a direction I-I′ of FIG. 1;

FIG. 5 is a cross-sectional view taken along a direction II-II′ of FIG. 1;

FIG. 6 is a plan view showing a modified example of a via hole of a direct power feeding type PCB stacked waveguide antenna structure according to an exemplary embodiment of the present disclosure;

FIG. 7 is a cross-sectional view showing a distance relationship between a waveguide and a via hole in a direct power feeding type PCB stacked waveguide antenna structure according to an exemplary embodiment of the present disclosure;

FIG. 8 is a beam pattern graph of a direct power feeding type PCB stacked waveguide antenna structure according to an exemplary embodiment of the present disclosure;

FIG. 9 is a cross-sectional view showing several modified examples of a waveguide of a direct power feeding type PCB stacked waveguide antenna structure according to an exemplary embodiment of the present disclosure;

FIG. 10 is a cross-sectional view of a direct power feeding type PCB stacked waveguide antenna structure according to a second embodiment of the present disclosure;

FIG. 11 is a cross-sectional view of a direct power feeding type PCB stacked waveguide antenna structure according to a third embodiment of the present disclosure;

FIG. 12 is a cross-sectional view of a direct power feeding type PCB stacked waveguide antenna structure according to a fourth embodiment of the present disclosure;

FIG. 13 is a cross-sectional view of a direct power feeding type PCB stacked waveguide antenna structure according to a fifth embodiment of the present disclosure;

FIG. 14 is a cross-sectional view of a direct power feeding type PCB stacked waveguide antenna structure according to a sixth embodiment of the present disclosure; and

FIG. 15 is a cross-sectional view of a direct power feeding type PCB stacked waveguide antenna structure according to a seventh embodiment of the present disclosure.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their invention.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

Terms and words used in the present specification and claims should not be construed as limited to their usual or dictionary definition, and they should be interpreted as a meaning and concept consistent with the technical idea of the present disclosure based on the principle that inventors may appropriately define the terms and concept in order to describe their own disclosure in the best way.

Accordingly, the embodiments described in the present specification and the configurations shown in the drawings correspond to preferred embodiments of the present disclosure, and do not represent all the technical idea of the present disclosure, so the configurations may have various examples of equivalent and modification that can replace them at the time of filing the present disclosure.

The waveguide antenna structure according to an exemplary embodiment of the present disclosure is a waveguide antenna structure configured to form a conduit through routing on a stacked PCB, form a waveguide by forming via holes on both sides of the conduit, and then have a base layer with a feed hole to directly feed the waveguide, and an antenna layer for transmitting or receiving RF signals transmitted from the waveguide.

Accordingly, the waveguide antenna structure according to an exemplary embodiment of the present disclosure has a simple structure and is configured to directly feed power, thereby reducing signal loss. Hereinafter, a waveguide antenna structure according to an exemplary embodiment of the present disclosure will be described in detail with reference to different drawings. In the present specification, the thickness of each layer constituting the waveguide antenna structure is exaggerated for clarity of description.

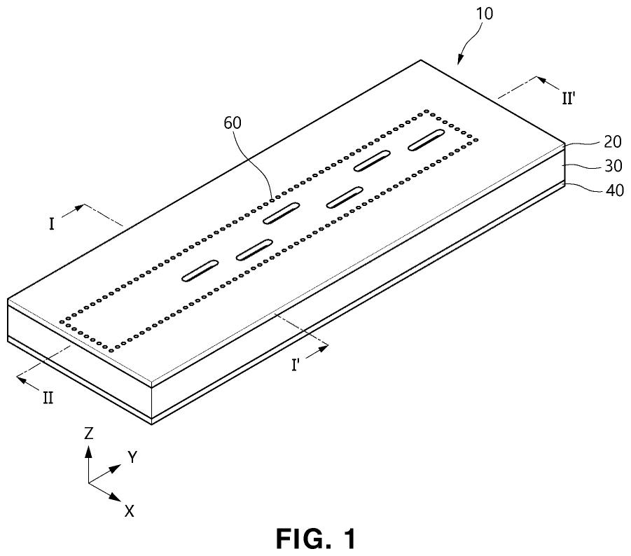

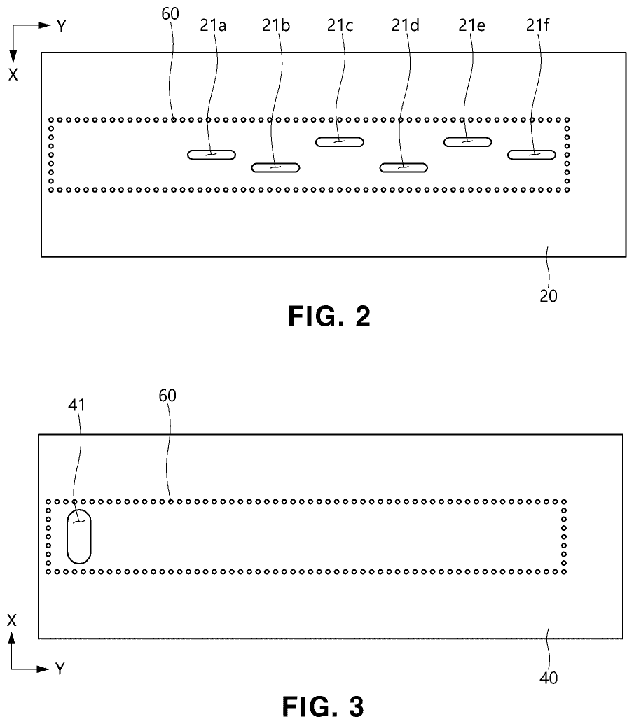

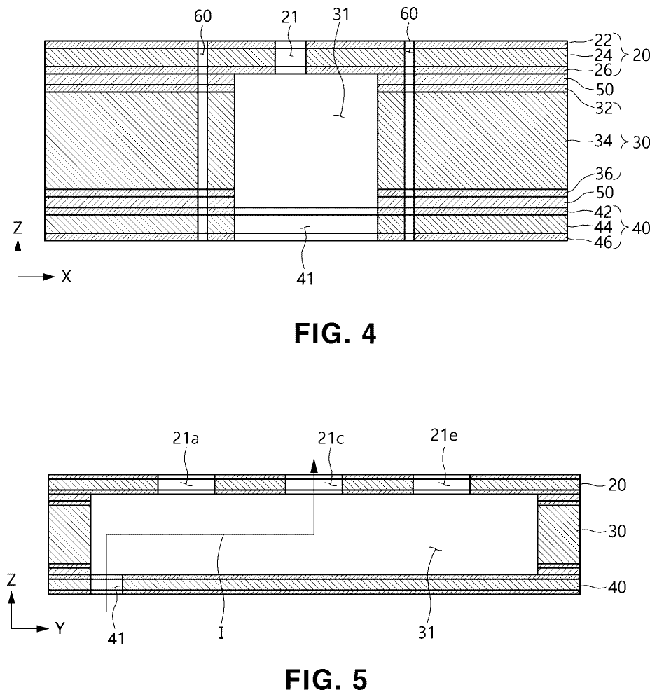

FIG. 1 is a perspective view of a direct power feeding type PCB stacked waveguide antenna structure according to an exemplary embodiment of the present disclosure. FIG. 2 is a plan view of a direct power feeding type PCB stacked waveguide antenna structure according to an exemplary embodiment of the present disclosure. FIG. 3 is a bottom view of a direct power feeding type PCB stacked waveguide antenna structure according to an exemplary embodiment of the present disclosure. FIG. 4 is a cross-sectional view taken along a direction I-I′ of FIG. 1. FIG. 5 is a cross-sectional view taken along a direction II-II′ of FIG. 1.

Referring to FIGS. 1 to 5, a waveguide antenna structure 10 according to an exemplary embodiment of the present disclosure includes an antenna layer 20, a waveguide layer 30, and a base layer 40.

The antenna layer 20 may be a layer disposed at the top of the waveguide antenna structure according to an exemplary embodiment of the present disclosure, and an antenna for transmitting and receiving an RF signal transmitted through a waveguide to be described later may be disposed on or in the antenna layer 20.

In an embodiment of the present disclosure, the antenna formed on or in the antenna layer 20 may be a slot antenna. However, the antenna formed on or in the antenna layer 20 is not limited thereto, and various types of antennas in which RF signals may be transmitted or received, such as horn antennas or patch antennas, may be used. In the present embodiment, referring to FIGS. 1 and 2, the slot antenna formed on or in the antenna layer 20 may include a plurality of antenna holes 21.

As shown in FIGS. 1 and 2, the plurality of antenna holes 21 may include six slots 21a, 21b, 21c, 21d, 21e, and 21f arranged in two rows in the y-axis direction as shown in FIG. 2. However, according to some embodiments of the present disclosure, the size, number, and arrangement of antenna holes may vary depending on the characteristics of the antenna.

In the present embodiment, the six slots 21a, 21b, 21c, 21d, 21e, and 21f are formed to penetrate the antenna layer 20 in the up-down (i.e. vertical) direction. In this case, the six slots 21a, 21b, 21c, 21d, 21e, and 21f are alternately arranged between neighboring slots to transmit or receive RF signals transmitted through the waveguide.

The shape, size, and arrangement of the six slots may be varied depending on the operating frequency, performance, and the like of the transmitted or received RF signal.

Referring to FIG. 4, in an embodiment of the present disclosure, the antenna layer 20 may include a first board 24, and a first protective layer 22 and a second protective layer 26 formed on the upper surface and lower surface of the first board 24, respectively.

According to an embodiment of the present disclosure, the first board 24 may be formed of, for example, a glass epoxy material such as FR-4. However, the material forming the first board 24 is not limited thereto, and the first board 24 may be formed of any material capable of forming a board.

The first board 24 may have a thin plate shape. The thickness of the first board 24 may be varied according to the operating frequency and performance of the antenna and the waveguide, which may be changed according to design of an antenna.

Meanwhile, the first protective layer 22 and the second protective layer 26 of the first board 24 may be formed in a form in which a material capable of forming plating and having conductivity. For example, the first protective layer 22 and the second protective layer 26 may be implemented as one or combination of a copper foil and a copper plating layer, although not required. The thickness of the antenna layer 20 may also be varied by the thickness of the first protective layer 22 and the second protective layer 26.

Referring to FIG. 4, a waveguide layer 30 is coupled to the lower part or bottom surface of the antenna layer 20.

The waveguide layer 30 may include a second board 34, and a first protective layer 32 and a second protective layer 36 formed on the upper surface and lower surface of the second board 34, respectively.

The second board 34 may be made of, for example, a glass epoxy material such as FR-4 which is the same or similar material as or to the first board 24. However, the material of the second board 34 is not limited thereto. In addition, the first protective layer 32 and the second protective layer 36 formed on the upper surface and lower surface of the second board 34 may be formed in the same or similar way or material as or to the first protective layer 22 and the second protective layer 26 formed on the first board 24.

Meanwhile, referring to FIGS. 4 and 5, a waveguide 31 is formed in or at the second board 34.

As shown in FIGS. 4 and 5, the waveguide 31 may be formed to have a rectangular cross-section having a length extending in the y-axis direction, and may also be formed to have a rectangular cross-section having a width and height in the x-axis direction. The inside of the waveguide 31 may be filled with air, although not required. In this case, the width and height of the waveguide 31 in the x-axis direction and the length of the waveguide 31 in the y-axis direction may vary in design depending on the frequency and performance of the RF signal. In FIG. 5, an arrow I indicates a moving or transmitting direction of an RF signal moving or transmitting from the base layer 20 to the antenna layer 40. According to an exemplary embodiment of the present disclosure, a plurality of waveguides may be formed in the second board 34 to form a waveguide antenna structure, and each of the plurality of waveguides may be individually connected to each of the plurality of feed holes. In this case, each of the plurality of waveguides may be used for transmission or reception of a signal. At least one waveguide antenna structure may include at least one waveguide for transmission and one waveguide for reception. In this disclosure, for the sake of simplicity of the drawing, a structure in which one waveguide 31 is connected to one feed hole 41 in the waveguide antenna structure is illustrated.

In an embodiment of the present disclosure, the antenna layer 20 and the waveguide layer 30 may be adhered by an adhesive layer 50. The adhesive layer 50 may be formed using, for example, but not limited to, a bonding sheet, a prepreg, or an adhesive such as glue.

Meanwhile, referring to FIGS. 4 and 5, in an embodiment of the present disclosure, the base layer 40 is coupled to the lower part or bottom surface of the waveguide layer 30.

The base layer 40 may include a third board 44, and a first protective layer 42 and a second protective layer 46 formed on the upper surface and lower surface of the third board 44, respectively.

The third board 44 may be formed of a glass epoxy material (e.g. FR-4), same as or similar to the first board 24 and the second board 34. However, the material forming the third board 44 is not limited thereto, and the third board 44 may be formed of any material capable of forming a board.

The third board 44 may have, for example, but not limited to, a thin plate shape. The first protective layer 42 and the second protective layer 46 formed on the upper surface and lower surface of the third board 44 may be formed in the same or similar way or material as or to the first protective layer 32 and the second protective layer 36 formed on the first board 24 and the second board 34.

In an embodiment of the present disclosure, a feed hole 41 is formed through the base layer 40 in the up-down direction (i.e. a direction in which the antenna layer 20, the waveguide layer 30, and the base layer 40). The feed hole 41 is a hole through which an RF signal directly fed from an RF signal generator passes.

In an embodiment of the present disclosure, referring to FIG. 5, the upper side or portion of the feed hole 41 is connected to one end side of the waveguide 31, and accordingly, the RF signal may pass through the feed hole 41, then pass through the waveguide 31, and be emitted to the outside of the waveguide antenna structure 10 through the antenna layer 20.

The area where the feed hole 41 is connected to the waveguide 31 may vary depending on the antenna design. However, according to an exemplary embodiment of the present disclosure, if the upper side of the feed hole 41 is not connected to the waveguide 31 in communication, the RF signal transmitted through the feed hole 41 cannot pass through the waveguide 31, so the upper side of the feed hole 41 must communicate with the waveguide 31.

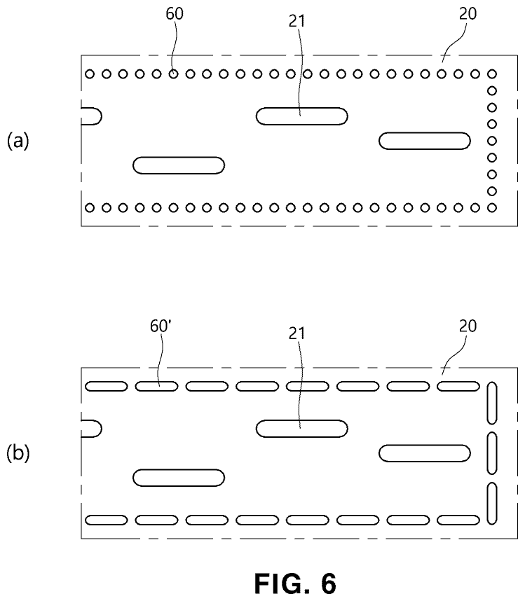

FIG. 6 is a plan view showing a modified example of a via hole of a direct power feeding type PCB stacked waveguide antenna structure according to an exemplary embodiment of the present disclosure. In an example shown in (a) of FIG. 6, the via hole 60 has a circular shape, and in another example shown in (b) of FIG. 6, the via hole 60′ has an elliptical shape.

Referring to FIGS. 1, 4, and 6 (a), in an embodiment of the present disclosure, a plurality of via holes 60 penetrate three layers, the base layer 40, the waveguide layer 30, and the antenna layer 20.

In an embodiment of the present disclosure, referring to FIG. 3, the plurality of via holes 60 are arranged to surround the feed hole 41, the waveguide 31, and the antenna hole 21 when viewed in the z-axis direction.

Referring to FIGS. 1 and 2, in an embodiment of the present disclosure, the plurality of via holes 60 are arranged in a substantially rectangular shape extending along the extension direction of the waveguide 31 in which the waveguide 31 extends, that is, the y-axis direction.

In this case, the plurality of via holes 60 may have a substantially circular shape as illustrated in (a) of FIG. 6, a substantially elliptical shape as illustrated in (b) of FIG. 6, or any shape such as a quadrangular, square, or rectangular shape. The extended length of the elliptical or rectangular via hole may be varied depending on the design.

The plurality of via holes 60 are configured to prevent radio wave leakage caused by the spacing between the layers formed by the adhesive layer 59 when three layers, which are the antenna layer 20, the waveguide layer 30, and the base layer 40, are bonded by the adhesive layer 50.

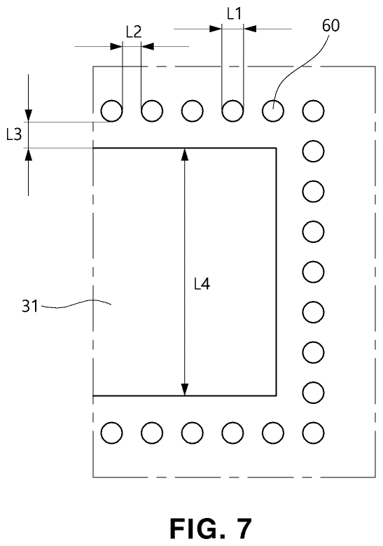

FIG. 7 is a cross-sectional view showing a distance relationship between a waveguide 31 and a via hole 60 in a direct power feeding type PCB stacked waveguide antenna structure 10 according to an exemplary embodiment of the present disclosure.

According to an exemplary embodiment of the present disclosure, the via hole 60 is a structure for preventing radio wave leakage at least in a part where a plating layer is not formed, and it is preferable to maintain an interval in which the operating frequency of the RF signal does not pass.

To this end, it is preferable that the interval L2 between adjacent via holes 60 is designed to be less than or equal to ½λ of the frequency of the RF signal passing through the waveguide 31 (λ is a wavelength of an RF signal). The interval between the via holes 60 may be designed through the diameter, shape, and position of the via hole

Meanwhile, referring to FIG. 7, the distance L3 between the waveguide 31 and the via hole 60 may be at least 0.05 mm, and may be varied for designing the waveguide antenna structure 10 in consideration of the operating frequency of the RF signal during design. If the distance L3 between the waveguide 31 and the via hole 60 is too short, it may be difficult to manufacture the via hole 60.

In addition, the width of the waveguide 31 can be designed according to the diameter L1, shape, size, and position of the via hole 60, so the width L4 of the waveguide 31 can be designed according to the operating frequency of the RF signal.

In this case, the width L4 of the waveguide 31 may be designed to have a smaller value as the operating frequency of the RF signal increases.

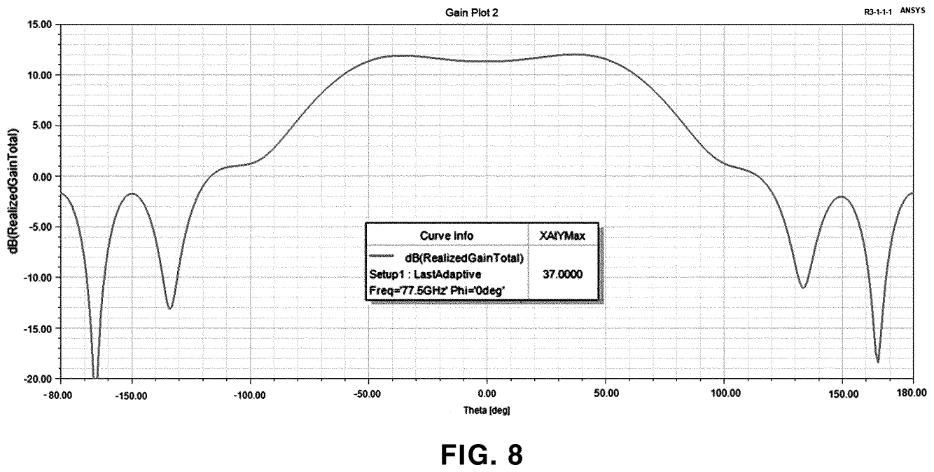

FIG. 8 is a beam pattern graph of a direct power feeding type PCB stacked waveguide antenna structure of according to an exemplary embodiment of the present disclosure.

With reference to FIG. 8, a beam pattern graph having a gain curve having a predetermined frequency at a predetermined angle may be obtained using a direct power feeding type PCB stacked waveguide antenna structure according to an exemplary embodiment of the present disclosure. In this case, the frequency value at the predetermined angle may be variously changed depending on the design of the waveguide antenna.

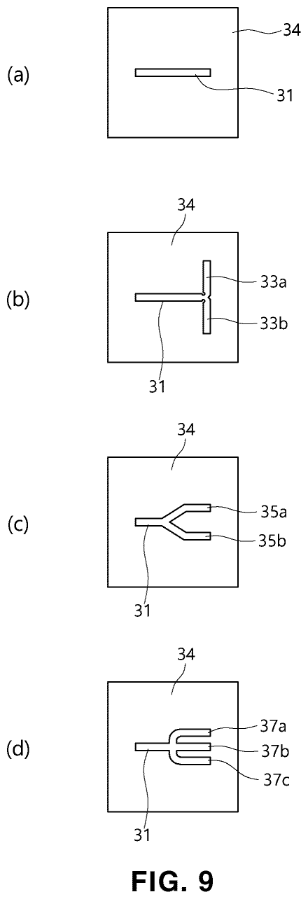

FIG. 9 is a cross-sectional view showing some examples of a waveguide of a direct power feeding type PCB stacked waveguide antenna structure according to exemplary embodiments of the present disclosure. (a) of FIG. 9 is an example in which a straight waveguide is formed, and (b) to (d) of FIG. 9 are examples in which two or more distribution waveguides are formed to be connected to a waveguide.

Referring to (b) to (d) of FIG. 9, the waveguide 31 according to certain exemplary embodiments of the present disclosure may include two or more distribution waveguides (e.g. 33a, 33b of (b) of FIG. 9, 35a, 35b of (c) of FIGS. 9, and 37a, 37b, and 37c of (d) of FIG. 9 on the other end of the waveguide 31, spaced apart from one end to which the feed hole 41 is connected.

In this case, as shown in (b) of FIG. 9, a first distribution waveguide 33a and a second distribution waveguide 33b may be arranged at an interval of 180 degrees, as shown in (c) of FIG. 9, a first distribution waveguide 35a and a second distribution waveguide 35b may be arranged parallelly or side by side to extend in the y-axis direction, or as shown in (d) FIG. 9, three distribution waveguides 37a, 37b, and 37c may be arranged parallelly or side by side to extend in the y-axis direction.

By forming two or more distribution waveguides as described above, the pattern of gain of the RF signal may be changed depending on the shape or number of the distribution waveguides.

The shape and number of such waveguides and distribution waveguides may vary depending on the size, antenna arrangement, and requirements of the entire antenna module.

When the number of distribution waveguides is plural, an interval in the width direction between the plurality of distribution waveguides, that is, an interval between the x-axis directions, may be set to 1λ or less. Such an interval is an interval determined by an array factor, and may be preferably arranged at an interval of 0.5λ, but may be arranged up to 1λ depending on the design.

Since the waveguide antenna structure according to an exemplary embodiment of the present disclosure manufactures a waveguide antenna structure by stacking boards, the manufacturing of the waveguide antenna structure may become easy and the cost for manufacturing the waveguide antenna structure may be reduced.

In addition, the waveguide antenna structure according to an exemplary embodiment of the present disclosure may form a board using a glass epoxy material such as FR-4, and form the waveguide penetrating through the board, so it is possible to simplify the manufacturing process of a waveguide.

In addition, since a waveguide antenna structure according to an exemplary embodiment of the present disclosure manufactures may have a structure that directly feeds to the waveguide by combining a base layer with a feed hole directly connected to the waveguide layer, it may have an advantage of low signal loss with comparison to a structure that indirectly transfers radio waves to the waveguide using microstrip.

Various modified embodiments of a waveguide antenna structure that may be formed to have a structure different from that of the above-described embodiment will be described with reference to different drawings. Hereinafter, in describing modified embodiments of the waveguide antenna structure according to various other embodiments of the present disclosure, the same or similar configuration as the above-described embodiments will be described using the same reference numerals, and with regard to the modified embodiments, configuration different from the above-described embodiments will be described as follows.

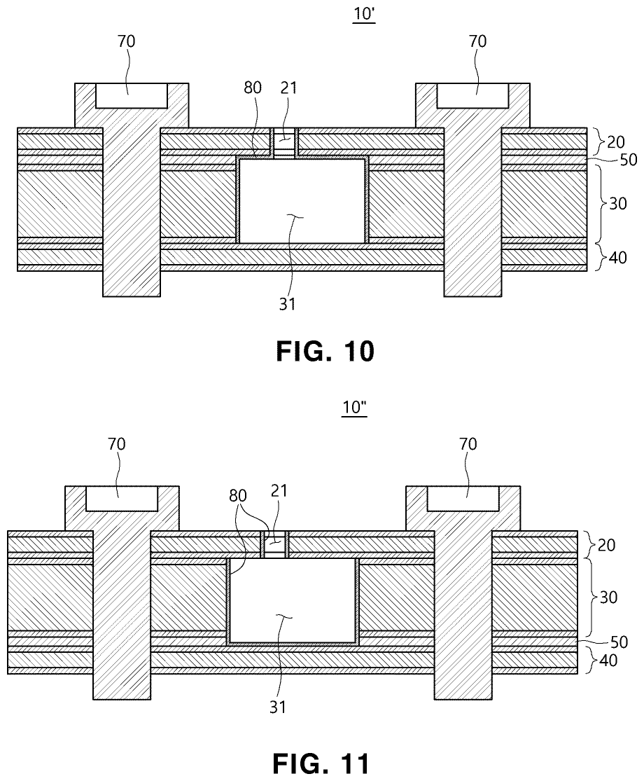

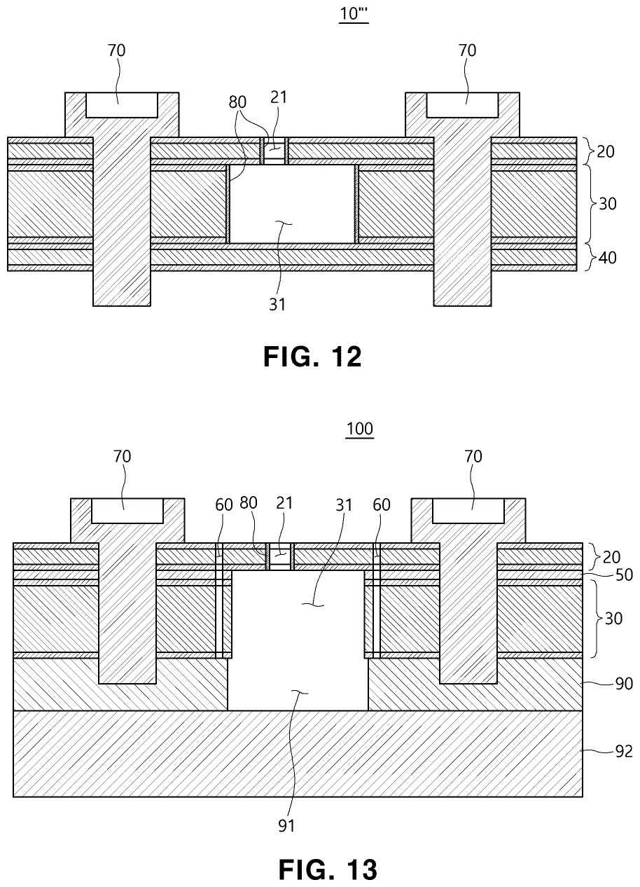

FIG. 10 is a cross-sectional view of a direct power feeding type PCB stacked waveguide antenna structure according to a second embodiment of the present disclosure. FIG. 11 is a cross-sectional view of a direct power feeding type PCB stacked waveguide antenna structure according to a third embodiment of the present disclosure. FIG. 12 is a cross-sectional view of a direct power feeding type PCB stacked waveguide antenna structure according to a fourth embodiment of the present disclosure.

According to several other embodiments of the present disclosure, the antenna layer 20, the waveguide layer 30, and the base layer 40 may be fastened by a faster or fastening member such as a bolt member 70 without using an adhesive layer.

In the second embodiment of the present disclosure, an adhesive layer 50 may be disposed between the antenna layer 20 and the waveguide layer 30, but an adhesive layer may not be formed between the waveguide layer 30 and the base layer 40.

Accordingly, while the antenna layer 20 and the waveguide layer 30 may be adhered by the adhesive layer 50, the base layer 40 may be coupled to the waveguide layer 30 by a fastener or a fastening member such as the bolt member 70.

In this example, an end of the bolt member 70 may be coupled to an RF board to couple the waveguide antenna structure 10 to the RF board.

The waveguide antenna structure 10′ according to the second embodiment of the present disclosure may not include the via hole 60, unlike the first embodiment described above.

In this case, referring to FIG. 10, the waveguide antenna structure 10′ according to the second embodiment has a plating layer 80 formed on a horizontal plane between the inner wall of the antenna hole 21, the inner wall of the waveguide 31, the lower end of the inner wall of the antenna hole, and the upper end of the inner wall of the waveguide to prevent radio wave leakage through the adhesive layer 50 formed between the antenna layer 20 and the waveguide layer 30. The radio wave leakage can be prevented by the plating layer 80. In FIG. 10, a view of the feed hole formed in the base layer 40 is omitted.

Meanwhile, referring to FIG. 11, the waveguide antenna structure 10″ according to the third embodiment of the present disclosure has an adhesive layer 50 interposed between the waveguide layer 30 and the base layer 40, unlike the second embodiment described above, and no adhesive layer may be interposed between the antenna layer 20 and the waveguide layer 30.

In the waveguide antenna structure 10″ according to the third embodiment of the present disclosure, the antenna layer 20, the waveguide layer 30, and the base layer 40 may be coupled to the RF board by a fastener or a fastening member such as the bolt member 70.

Referring to FIG. 11, in the waveguide antenna structure 10″ according to the third embodiment, a plating layer 80 is formed on the inner wall of the antenna hole 21, the inner wall of the waveguide 31, and the lower surface of the waveguide 31. Accordingly, radio waves may be prevented from leaking through the adhesive layer interposed between the waveguide layer 30 and the base layer 40. In FIG. 11, a view of the feed hole formed in the base layer 40 is omitted.

Meanwhile, referring to FIG. 12, the waveguide antenna structure 10′″ according to the fourth embodiment of the present disclosure is coupled to the upper part of the board such as the RF board by a fastener or a fastening member such as the bolt member 70, without an adhesive layer being interposed between all neighboring layers of the antenna layer 20, waveguide layer 30, and base layer 40, unlike the embodiments described above.

Since the plating layers of each layer are formed to be in contact with each other when the adhesive layer 50 is not interposed between neighboring layers, radio wave leakage can be prevented if the plating layer 80 is formed only on the inner surface of the antenna hole 21 and the inner surface of the waveguide 31, as shown in FIG. 12. In the second to fourth embodiments of the present disclosure, described with reference to FIGS. 10 to 12, the antenna layer 20, the waveguide layer 30, and the base layer 40 are formed without using the via hole 60, and then two neighboring layers of the three layers are bonded to each other while the other layer is bonded to the RF board using a fastener or a fastening member such as a bolt member 70, or each of the three layers is bonded to the RF board using a fastener or a fastening member such as a bolt member 70. Accordingly, in some embodiments of the present disclosure, in forming the waveguide antenna structure, the process of forming the via hole 60 can be omitted.

A waveguide antenna structure according to another embodiment of the present disclosure may be formed such that a waveguide layer is directly stacked on an RF board, unlike the waveguide antenna structure having the above-described structure. Hereinafter, waveguide antenna structures according to yet various other embodiments of the present disclosure will be described with reference to different drawings. Hereinafter, in describing modified embodiments of the waveguide antenna structure according to yet various other embodiments of the present disclosure, the same or similar configuration as the above-described embodiments will be described using the same reference numerals, and with regard to the modified embodiments, configuration different from the above-described embodiments will be described as follows.

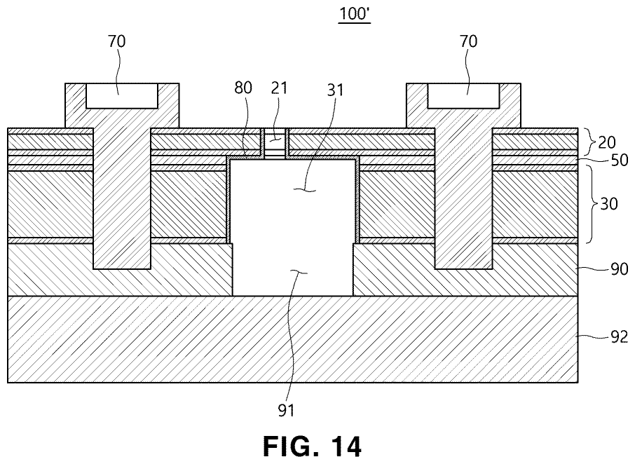

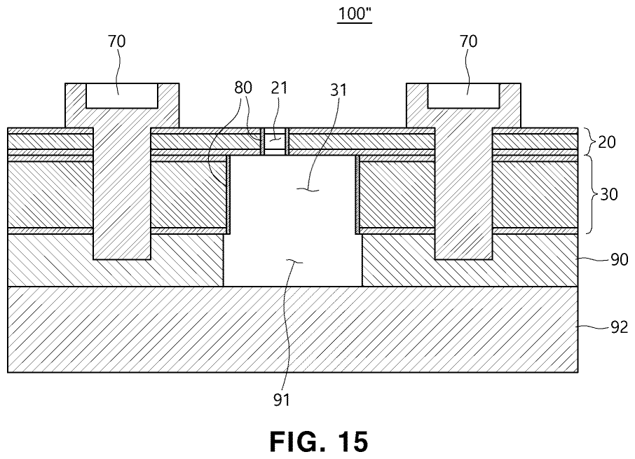

FIG. 13 is a cross-sectional view of a direct power feeding type PCB stacked waveguide antenna structure according to a fifth embodiment of the present disclosure. FIG. 14 is a cross-sectional view of a direct power feeding type PCB stacked waveguide antenna structure according to a sixth embodiment of the present disclosure. FIG. 15 is a cross-sectional view of a direct power feeding type PCB stacked waveguide antenna structure according to a seventh embodiment of the present disclosure.

Referring to FIGS. 13 to 15, waveguide antenna structures 100, 100′, and 100″ according to yet another embodiment of the present disclosure may not include the base layer 40, unlike the above-described embodiments, but may include the antenna layer 20, the waveguide layer 30, an RF board 90, and an monolithic microwave integrated circuit (MMIC) chip 92.

Like the waveguide antenna structure according to the second embodiment shown in FIG. 10, in the waveguide antenna structure 100 according to the fifth embodiment shown in FIG. 13, the antenna layer 20 and the waveguide layer 30 may be coupled by the adhesive layer 50.

In this case, the antenna layer 20 and the waveguide layer 30 may be coupled to the RF board 90 by a bolt member 70.

In FIG. 13, the MMIC chip 92 is mounted on the lower part of the RF board 90. The MMIC chip 92 may be a chip that directly generates an RF feed signal. The RF feed signal generated from the MMIC chip 92 may be transferred to the antenna hole 21 through the waveguide 31 formed in the waveguide layer 30 through the feed hole 91 formed in the RF board 90.

Like the first embodiment, in the waveguide antenna structure 100 according to the fifth embodiment, a plurality of via holes 60 may be formed to penetrate the antenna layer 20 and the waveguide layer 30 to prevent radio wave leakage.

As another example, as shown in FIG. 14, in the waveguide antenna structure 100′ according to the sixth embodiment, a plurality of via holes 60 may be not formed, unlike the waveguide antenna structure according to the fifth embodiment of FIG. 13, and a plating layer 80 for preventing radio wave leakage may be formed on the inner surface of the antenna hole 21 and the inner surface of the waveguide 31.

The waveguide antenna structures 100, 100′ according to the fifth and sixth embodiments of the present disclosure may be formed as a waveguide antenna structure having a simpler structure by forming the feed hole 91 on an RF board instead of the base layer 40 in which a feed hole 91 through which a directly fed RF signal passes is formed.

Meanwhile, like the fifth and sixth embodiments, the waveguide antenna structure 100″ according to the seventh embodiment of the present disclosure may not include the base layer 40. And, the waveguide antenna structure 100″ according to the seventh embodiment of the present disclosure is configured so that the antenna layer 20 and the waveguide layer 30 are not coupled by the adhesive layer 50, but are directly coupled to the RF board 90 by a fastener or a fastening member such as the bolt member 70.

In this case, in the waveguide antenna structure 100″ according to the seventh embodiment of the present disclosure, a plating layer 80 is formed on the inner surface of the antenna hole 21 and the inner surface of the waveguide 31.

Accordingly, the waveguide antenna structure 100″ according to the seventh embodiment of the present disclosure may form a waveguide antenna structure by directly fastening the antenna layer 20 and the waveguide layer 30 to the RF board 90 using a fastener or a fastening member such as the bolt member 70 without having a separate via hole 60.

According to the fifth to seventh embodiments of the present disclosure, a waveguide antenna structure can be easily manufactured by directly bonding the antenna layer 20 and the waveguide layer 30 to the RF board 90 using a bolt 70 while the antenna layer 20 and the waveguide layer 30 are coupled, or fastening to the RF board 90 using a bolt 70 while the antenna layer 20 and the waveguide layer 30 are separated.

In addition, the waveguide antenna structures 100, 100′, and 100″ according to the fifth to seventh embodiments of the present disclosure can reduce the cost of manufacturing waveguide antennas compared to the waveguide antenna structures 10, 10′, 10″, and 10″ according to the first to fourth embodiments by not using the base layer 40.

According to the above configuration, in the waveguide antenna structure and apparatus according to an exemplary embodiment of the present disclosure, an RF signal may be directly fed from an MMIC chip generating an RF signal and transmitted or received to the waveguide antenna.

Since the waveguide antenna structure according to some exemplary embodiments of the present disclosure forms a waveguide by stacking PCB boards, an antenna can be manufactured at a lower cost.

In addition, the waveguide antenna structure according to certain exemplary embodiments of the present disclosure may manufacture an antenna using one or more PCB boards, thereby being easy to be fastened to the RF board.

In addition, since the waveguide antenna structure according to some exemplary embodiments of the present disclosure may be implemented as a direct power feeding type, it is possible to reduce the signal loss that may occur during the signal transfer from the conventional microstrip to the waveguide.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A waveguide antenna structure, comprising:
a base layer having a feed hole configured such that radio frequency (RF) signals pass through the feed hole of the base layer;
a waveguide layer stacked on the base layer and having a waveguide communicating with the feed hole of the base layer; and
an antenna layer stacked on the waveguide layer and having an antenna configured to transmit or receive the RF signals passing through the feed hole of the base layer and the waveguide of the waveguide layer to or from an outside of the waveguide antenna structure.

2. The waveguide antenna structure of claim 1,
wherein each of the antenna layer, the waveguide layer, and the base layer comprises:
a board layer; and
a first protective layer and a second protective layer stacked on one surface and an opposite surface of the board layer, respectively.

3. The waveguide antenna structure of claim 1,
wherein a first adhesive layer is interposed between the base layer and the waveguide layer and a second adhesive layer is interposed between the waveguide layer and the antenna layer,
the waveguide antenna structure further has a plurality of via holes passing through the base layer, the waveguide layer, and the antenna layer, and
the plurality of via holes are arranged to surround the feed hole, the waveguide, and the antenna when viewed in a first direction in which the base layer, the waveguide layer, and the antenna layer are stacked.

4. The waveguide antenna structure of claim 3, wherein the antenna is a slot antenna comprising a plurality of antenna holes.

5. The waveguide antenna structure of claim 4,
wherein the waveguide is formed to extend in a second direction perpendicular to the first direction in which the base layer, the waveguide layer, and the antenna layer are stacked,
the feed hole is formed at one end portion of the waveguide in the second direction, and
one or more of the plurality of antenna holes are spaced apart from the feed hole in the second direction and arranged along a direction in which the waveguide extends.

6. The waveguide antenna structure of claim 4, wherein an interval between neighboring via holes of the plurality of via holes is less than or equal to half of a wavelength of one of the RF signals passing through the waveguide.

7. The waveguide antenna structure of claim 5,
further comprising two or more distribution waveguides connected to another end portion of the waveguide,
wherein the two or more distribution waveguides extend in the second direction or include portions extending in a direction perpendicular to the second direction, and an interval between the two or more distribution waveguides is less than or equal to a wavelength of one of the RF signals passing through the waveguide.

8. The waveguide antenna structure of claim 1,
further comprising two or more fasteners coupling the base layer, the waveguide layer, and the antenna layer,
wherein the two or more fasteners are disposed on both sides of the base layer, the waveguide layer, and the antenna layer.

9. The waveguide antenna structure of claim 8,
wherein the two or more fasteners comprise a bolt member, and
the bolt member has a head portion disposed on the antenna layer, and an end portion protruding from a surface of the base layer and coupled to an RF board having a monolithic microwave integrated circuit (MMIC) chip configured to generate the RF signals toward the feed hole.

10. The waveguide antenna structure of claim 8, further comprising:
an adhesive layer interposed between the base layer and the waveguide layer or between the antenna layer and the waveguide layer; and
a plating layer formed between the base layer and the waveguide layer or between the antenna layer and the waveguide layer.

11. A waveguide antenna structure, comprising:
a monolithic microwave integrated circuit (MMIC) chip configured to generate radio frequency (RF) signals;
an RF board, wherein the MMIC chip is mounted on one surface the RF board and the RF board has a feed hole configured to transmit the RF signals generated by the MMIC chip;
a waveguide layer stacked on an other surface of the RF board and having a waveguide communicating with the feed hole of the RF board; and
an antenna layer stacked on the waveguide layer and having one or more antenna holes configured to transmit or receive the RF signals passing through the feed hole of the RF board and the waveguide of the waveguide layer to or from an outside of the waveguide antenna structure.

12. The waveguide antenna structure of claim 11,
further comprising two or more fasteners coupling the RF board, the waveguide layer, and the antenna layer,
wherein the two or more fastener are disposed on both sides of the RF board, the waveguide layer, and the antenna layer.

13. The waveguide antenna structure of claim 11, further comprising a plating layer disposed on an inner surface of the waveguide of the waveguide layer and an inner surface of the one or more antenna holes of the antenna layer.

14. The waveguide antenna structure of claim 11,
wherein the two or more fasteners comprise a bolt member, and
the bolt member has a head portion disposed on the antenna layer, and an end portion protruding from a surface of the antenna layer and coupled to the RF board.

15. The waveguide antenna structure of claim 11, further comprising:
an adhesive layer interposed between the antenna layer and the waveguide layer; and
a plating layer positioned between the antenna layer and the waveguide layer.

16. The waveguide antenna structure of claim 11,
wherein each of the antenna layer and the waveguide layer comprises:
a board layer; and
a first protective layer and a second protective layer stacked on one surface and an opposite surface of the board layer, respectively.

17. The waveguide antenna structure of claim 11,
wherein an adhesive layer is interposed between the waveguide layer and the antenna layer,
the waveguide antenna structure further has a plurality of via holes passing through the waveguide layer and the antenna layer, and
the plurality of via holes are arranged to surround the feed hole, the waveguide, and the one or more antenna holes when viewed in a first direction in which the waveguide layer and the antenna layer are stacked.

18. The waveguide antenna structure of claim 17,
wherein the waveguide is formed to extend in a second direction perpendicular to the first direction in which the waveguide layer and the antenna layer are stacked,
the feed hole is formed at one end of the waveguide in the second direction, and
the one or more antenna holes are spaced apart from the feed hole in the second direction and arranged along a direction in which the waveguide extends.

19. The waveguide antenna structure of claim 17, wherein an interval between neighboring via holes of the plurality of via holes is less than or equal to half of a wavelength of one of the RF signals passing through the waveguide.

20. The waveguide antenna structure of claim 18,
further comprising two or more distribution waveguides connected to another end portion of the waveguide,
wherein the two or more distribution waveguides extend in the second direction or include portions extending in a direction perpendicular to the second direction, and an interval between the two or more distribution waveguides is less than or equal to a wavelength of one of the RF signals passing through the waveguide.
